(19) United States
(12) Patent Application Publication
(10) Pub. No.: US 2011/0199768 A1
(43) Pub. Date: Aug. 18, 2011

(54) ASSEMBLED LED LAMP STRIP STRUCTURE AND LED LAMP HAVING THE SAME FOR CONTINUOUS LIGHTING

(75) Inventors: JUI-LUN KUO, CHANGHUA COUNTY (TW); YAO-I WANG, TAIPEI COUNTY (TW); FANG-PO WANG, TAIPEI COUNTY (TW)

(73) Assignee: LEDTECH ELECTRONICS CORP., TAIPEI COUNTY (TW)

(21) Appl. No.: 12/917,647

(22) Filed: Nov. 2, 2010

(30) Foreign Application Priority Data
Feb. 12, 2010 (TW) 99203220

(51) Int. Cl. F21S 4/00

(52) U.S. Cl. 362/249.02

(57) ABSTRACT

An assembled LED lamp strip structure for generating continuous lighting includes a substrate unit, a light-emitting unit and a packaging unit. The substrate unit has a plurality of substrate bodies sequentially and electrically connected to form a strip shape. The light-emitting unit has a plurality of linear light-emitting arrays respectively disposed on and electrically connected to the substrate bodies. Each linear light-emitting array has a plurality of light-emitting elements, and light beams generated by each light-emitting element are unobstructively projected outward. The packaging unit has a plurality of packaging bodies respectively disposed on the substrate bodies and respectively covering the linear light-emitting arrays, and the length of each packaging body is substantially the same as the length of each substrate body.

### BACKGROUND OF THE INVENTION

1. Field of the Invention

The instant disclosure relates to an assembled LED lamp strip structure and an LED lamp thereof; more particularly, to an assembled LED lamp strip structure and an LED lamp thereof for generating continuous lighting.

2. Description of Related Art

The invention of the lamp greatly changed the style of building construction and the living style of human beings, allowing people to work during the night. Traditional lighting devices such as lamps that adopt incandescent bulbs, fluorescent bulbs, or power-saving bulbs have been generally well-developed and used intensively for indoor illumination. However, compared to the newly developed light-emitting-diode (LED) lamps, these traditional lamps have the disadvantages of quick attenuation, high power consumption, high heat generation, short service life, high fragility, and not recyclable. Thus, various high-powered LED lamps are created to replace the traditional lighting devices. Among them, tubular LED lamps are gaining popularity for their dimensional resemblance of traditional fluorescent tubes and thus their adoptability to existing lighting devices.

However, the tubular LED lamp of the prior art has a plurality of LED lamp strips separated from each other by a large gap, thus a dark band is formed between every two LED lamp strips. In other words, the tubular LED lamp of the prior art cannot generated uniform continuous lighting due to the dark band generated in large gap between every two LED lamp strips.

### SUMMARY OF THE INVENTION

One particular aspect of the instant disclosure is to provide an assembled LED lamp strip structure for generating continuous and uniform lighting without any dark band.

Another particular aspect of the instant disclosure is to provide an LED lamp for generating continuous and uniform lighting without any dark band.

To achieve the above-mentioned advantages, the instant disclosure provides an assembled LED lamp strip structure for generating continuous lighting, including: a substrate unit, a light-emitting unit and a packaging unit. The substrate unit has a plurality of substrate bodies sequentially and electrically connected to form a strip shape. The light-emitting unit has a plurality of linear light-emitting arrays respectively disposed on and electrically connected to the substrate bodies. Each linear light-emitting array has a plurality of light-emitting elements, and light beams generated by each light-emitting element are unobstructively projected outside. The package unit has a plurality of packaging bodies respectively disposed on the substrate bodies and respectively covering the linear light-emitting arrays, and the length of each packaging body is substantially the same as the length of each substrate body.

To achieve the above-mentioned advantages, the instant disclosure provides a LED lamp for generating continuous lighting, including: a lamp structure and an assembled LED lamp strip structure. The lamp structure has at least one hollow light-permitting body and at least two conductive lateral covers respectively disposed on two opposite lateral ends of each hollow light-permitting body. The assembled LED lamp strip structure is received in each hollow light-permitting body, and the assembled LED lamp strip structure includes a substrate unit, a light-emitting unit and a packaging unit. The substrate unit has a plurality of substrate bodies sequentially and electrically connected to form a strip shape, and the substrate unit is electrically connected between the at least two conductive lateral covers. The light-emitting unit has a plurality of linear light-emitting arrays respectively disposed on and electrically connected to the substrate bodies, where each linear light-emitting array has a plurality of light-emitting elements, and light beams generated by each light-emitting element are unobstructively projected outside through each hollow light-permitting body. The packaging unit has a plurality of packaging bodies respectively disposed on the substrate bodies and respectively covering the linear light-emitting arrays, and the length of each packaging body is substantially the same as the length of each substrate body.

Therefore, the substrate bodies are tightly and sequentially connected to each other and the packaging bodies are tightly and sequentially connected to each other at the same time to form the assembled LED lamp strip structure with long strip shape, thus the instant disclosure can generate continuous and uniform lighting without any dark band.

To further understand the techniques, means and effects the instant disclosure takes for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention that they be used for limiting the instant disclosure.

### BRIEF DESCRIPTION OF THE DRAWINGS

FIG. 1A shows a lateral, schematic view of one part of the assembled LED lamp strip structure according to the first embodiment of the instant disclosure;

FIG. 1B shows one lateral, schematic view of the assembled LED lamp strip structure according to the first embodiment of the instant disclosure;

FIG. 1C shows a top, schematic view of the assembled LED lamp strip structure according to the first embodiment of the instant disclosure;

FIG. 1D shows another lateral, schematic view of the assembled LED lamp strip structure according to the first embodiment of the instant disclosure;

FIG. 2A shows a lateral, schematic view of one part of the assembled LED lamp strip structure according to the second embodiment of the instant disclosure;

FIG. 2B shows one lateral, schematic view of the assembled LED lamp strip structure according to the second embodiment of the instant disclosure;

FIG. 2C shows a top, schematic view of the assembled LED lamp strip structure according to the second embodiment of the instant disclosure;

FIG. 2D shows another lateral, schematic view of the assembled LED lamp strip structure according to the second embodiment of the instant disclosure;

FIG. 3 shows a lateral, schematic view of the LED lamp according to the third embodiment of the instant disclosure; and

FIG. 4 shows a lateral, schematic view of the LED lamp according to the fourth embodiment of the instant disclosure.

### DETAILED DESCRIPTION OF THE PREFERRED EMBODIMENTS

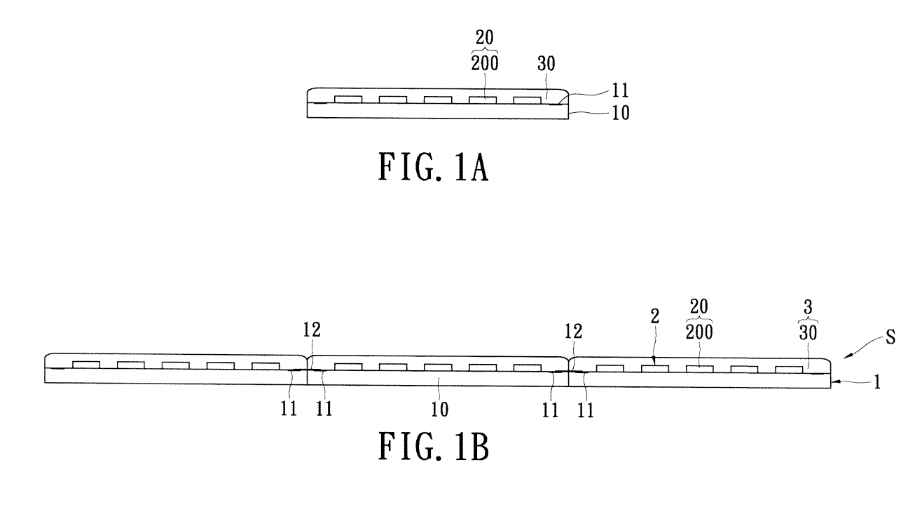

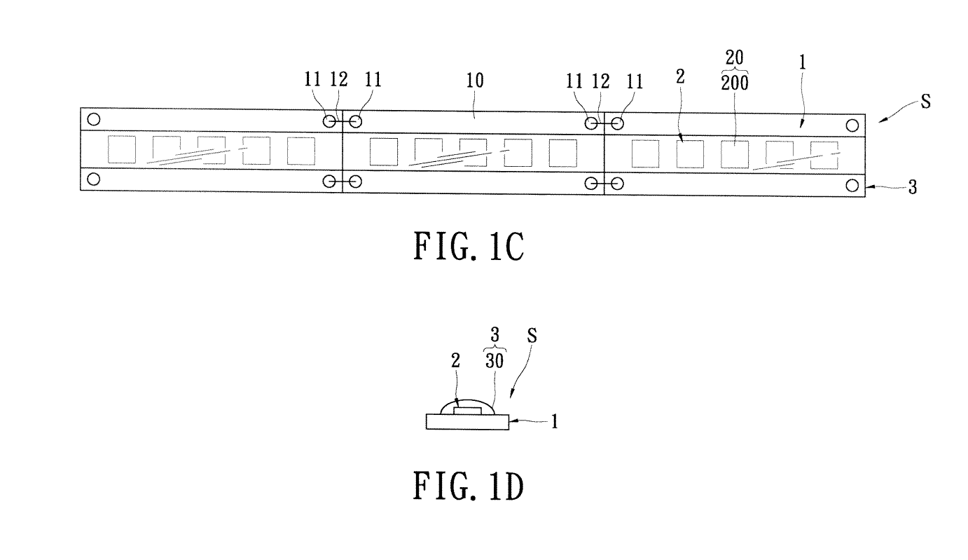

Referring to FIGS. 1A to 1C, the first embodiment of the instant disclosure provides an assembled LED lamp strip structure S for generating continuous lighting, including: a substrate unit 1, a light-emitting unit 2 and a packaging unit 3.

The substrate unit 1 has a plurality of substrate bodies 10 sequentially and electrically connected to form a strip shape, thus the substrate unit 1 can be shown as a strip shape. In addition, each substrate body 10 has at least four conductive pads 11 disposed on a top surface thereof, two of the at least four conductive pads 11 are disposed on a first end region of each substrate body 10, the other two of the at least four conductive pads 11 are disposed on a second end region of each substrate body 10, and the first end region and the second end region are two opposite end regions of the top surface of each substrate body 10. The substrate unit 1 has a plurality of conductive elements 12, where each conductive element 12 is electrically connected between two adjacent conductive pads 11 of two adjacent substrate bodies 10, thus the substrate bodies 10 can be sequentially and electrically connected to each other through the conductive elements 12.

Moreover, the light-emitting unit 2 has a plurality of linear light-emitting arrays 20 respectively disposed on and electrically connected to the substrate bodies 10. Each linear light-emitting array 20 has a plurality of light-emitting elements 200, and light beams generated by each light-emitting element 200 can be unobstructively projected outside. For example, the light-emitting elements 200 can be LED chips and the light-emitting elements 200 of each linear light-emitting array 20 can be electrically connected with each other in series and in parallel. Because the light-emitting elements 200 of each linear light-emitting array 20 is electrically connected with each other in series and in parallel (such as 8 series and 8 parallel), when one of light-emitting elements 200 is damaged, the light-emitting function of each linear light-emitting array 20 can be also maintained. In addition, the light-emitting elements 200 of each linear light-emitting array 20 can be electrically connected to circuits (not shown) formed on each substrate body 10, and the light-emitting elements 200 can be orderly arranged to form a strip shape.

Furthermore, the packaging unit 3 has a plurality of packaging bodies 30 respectively disposed on the substrate bodies 10 and respectively covering the linear light-emitting arrays 20. Each packaging body 30 is extended from the first end region to the second end region of the top surface of each substrate body 10, thus the length of each packaging body 30 is substantially the same as the length of each substrate body 10. For example, each packaging body 30 can be a phosphor resin that is formed by mixing phosphor powders with silicone or epoxy, and the packaging bodies 30 can be sequentially connected to form a strip shape, and each packaging body 30 on each substrate body 10 has an arc-shaped top surface as shown in FIG. 1D.

For example, in the first embodiment as shown in FIG. 1A, first, the light-emitting elements 200 of each linear light-emitting array 20 can be electrically connected to each substrate body 10 by wire-bonding or flip-chip method; Next, each linear light-emitting array 20 can be covered with each packaging body 30; Finally, the substrate bodies 10 are tightly and sequentially connected to each other and the packaging bodies 30 are tightly and sequentially connected to each other at the same time to form the assembled LED lamp strip structure S with long strip shape as shown in FIGS. 1B and 1C.

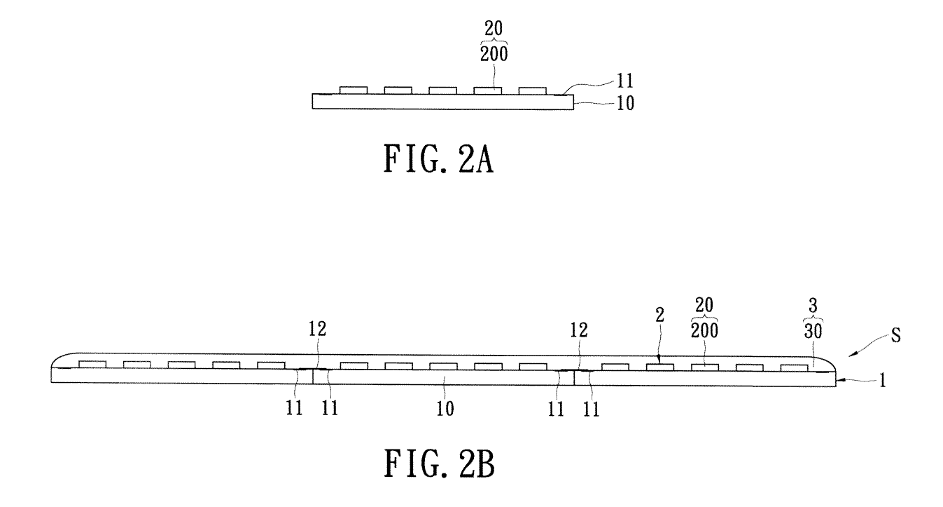

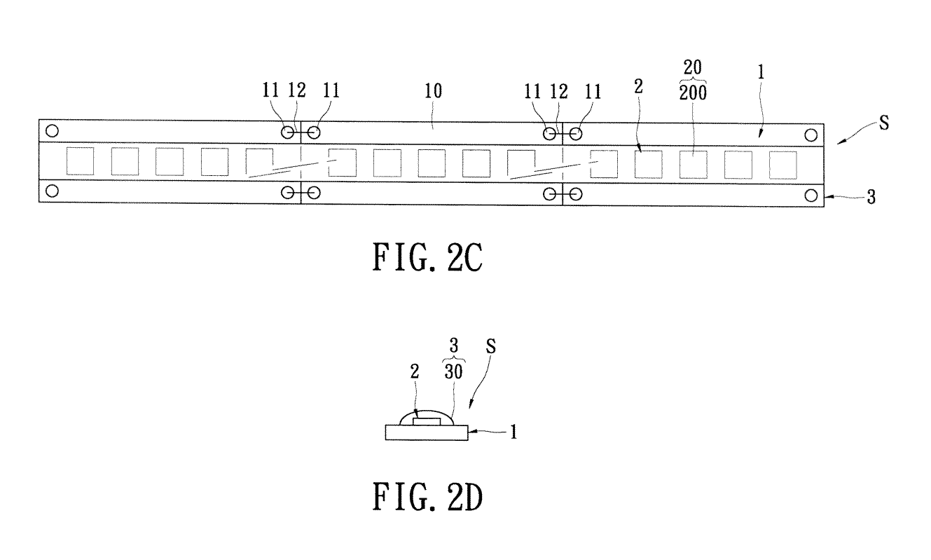

Referring to FIGS. 2A to 2C, where the second embodiment of the instant disclosure provides an assembled LED lamp strip structure for generating continuous lighting, including: a substrate unit 1, a light-emitting unit 2 and a packaging unit 3. The difference between the second embodiment and the first embodiment is that: in the second embodiment, the packaging unit 3 can be one-piece packaging body 30 disposed on the substrate bodies 10 and covering the linear light-emitting arrays 20. For example, the packaging body 30 can be a phosphor resin that is formed by mixing phosphor powders with silicone or epoxy, where the packaging body 30 may have a strip shape, and the packaging body 30 on the substrate bodies 10 has an arc-shaped top surface as shown in FIG. 2D.

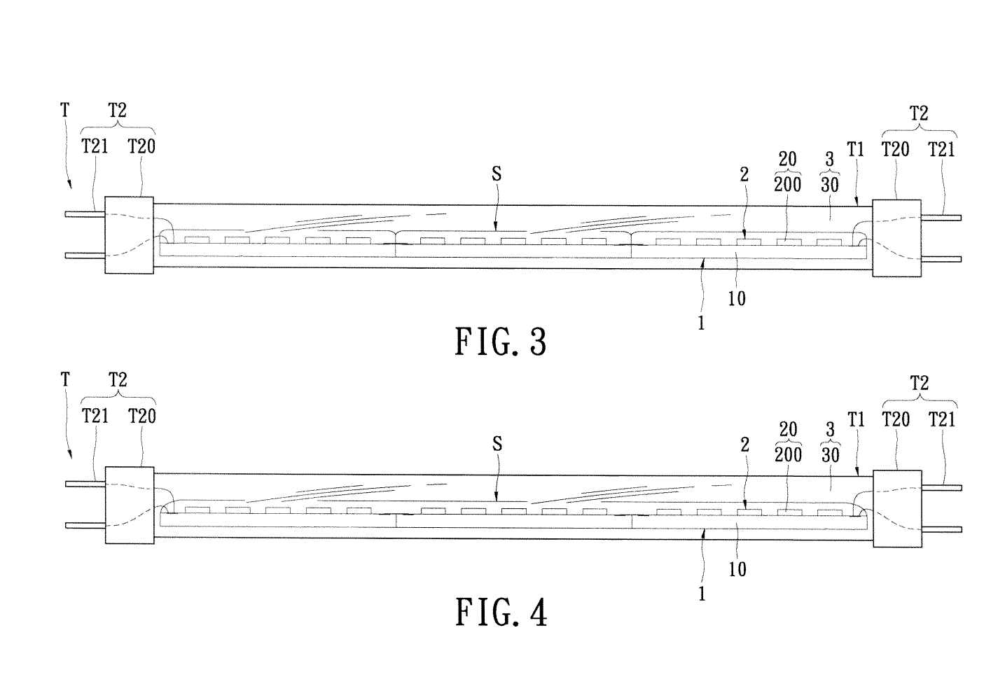

Referring to FIG. 3, where the third embodiment of the instant disclosure provides an LED lamp for generating continuous lighting, including: a lamp structure T and an assembled LED lamp strip structure S.

The lamp structure T has at least one hollow light-permitting body T1 and at least two conductive lateral covers T2 respectively disposed on (or installed on) two opposite lateral ends of each hollow light-permitting body T1. Each conductive lateral cover T2 has at least one cover body T20 and two conductive pins T21 passing through the cover body T20. In addition, the assembled LED lamp strip structure S is received in the hollow light-permitting body T1. The assembled LED lamp strip structure S can be the same as the first embodiment (as shown in FIGS. 1A to 1C), thus the assembled LED lamp strip structure S includes a substrate unit 1, a light-emitting unit 2 and a packaging unit 3.

Furthermore, the substrate unit 1 has a plurality of substrate bodies 10 sequentially and electrically connected to form a strip shape, and the substrate unit 1 is electrically connected between the at least two conductive lateral covers T2. In other words, the substrate unit 1 is electrically connected between the two conductive pins T21, and each conductive pin T21 is electrically connected to a corresponding conductive pad 11. The light-emitting unit 2 has a plurality of linear light-emitting arrays 20 respectively disposed on and electrically connected to the substrate bodies 10, where each linear light-emitting array 20 has a plurality of light-emitting elements 200, and light beams generated by each light-emitting element 200 are unobstructively projected outward through the hollow light-permitting body T1. The packaging unit 3 has a plurality of packaging bodies 30 respectively disposed on the substrate bodies 10 and respectively covering the linear light-emitting arrays 20, and the length of each packaging body 30 is substantially the same as the length of each substrate body 10.

Referring to FIG. 4, where the fourth embodiment of the instant disclosure provides an LED lamp for generating continuous lighting, including: a lamp structure T and an assembled LED lamp strip structure S. The assembled LED lamp strip structure S is received in the hollow light-permitting body T1, and the assembled LED lamp strip structure S includes a substrate unit 1, a light-emitting unit 2 and a packaging unit 3. The difference between the fourth embodiment and the third embodiment is that: in the fourth embodiment, the assembled LED lamp strip structure S can be the same as the second embodiment (as shown in FIGS. 2A to 2C).

In conclusion, the substrate bodies can be tightly and sequentially connected to each other and the packaging bodies can be tightly and sequentially connected to each other at the same time to form the assembled LED lamp strip structure with long strip shape, thus the instant disclosure can generate continuous and uniform lighting without any dark band.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. An assembled LED lamp strip structure for generating continuous lighting, comprising:
a substrate unit having a plurality of substrate bodies sequentially and electrically connected to form a strip shape;
a light-emitting unit having a plurality of linear light-emitting arrays respectively disposed on and electrically connected to the substrate bodies, wherein each linear light-emitting array has a plurality of light-emitting elements, and light beams generated by each light-emitting element are unobstructively projected outward; and
a packaging unit having a plurality of packaging bodies respectively disposed on the substrate bodies and respectively covering the linear light-emitting arrays, wherein the length of each packaging body is substantially the same as the length of each substrate body.

2. The assembled LED lamp strip structure as claimed in claim 1, wherein each substrate body has at least four conductive pads disposed on a top surface thereof, two of the conductive pads are disposed on a first end region of each substrate body, the other two conductive pads are disposed on a second end region of each substrate body, the substrate unit has a plurality of conductive elements, and each conductive element is electrically connected between two adjacent conductive pads of two adjacent substrate bodies.

3. The assembled LED lamp strip structure as claimed in claim 1, wherein the light-emitting elements of each linear light-emitting array are electrically connected with each other in series and in parallel.

4. The assembled LED lamp strip structure as claimed in claim 1, wherein the packaging bodies are sequentially aligned to form a strip shape.

5. The assembled LED lamp strip structure as claimed in claim 4, wherein each packaging body is phosphor resin.

6. The assembled LED lamp strip structure as claimed in claim 5, wherein the phosphor resin is formed by mixing phosphor powders with silicone.

7. The assembled LED lamp strip structure as claimed in claim 4, wherein each packaging body on each substrate body has an arc-shaped top surface.

8. An LED lamp for generating continuous lighting, comprising:
a lamp structure having at least one hollow light-permitting body and at least two conductive lateral covers respectively disposed on two opposite lateral ends of the at least one hollow light-permitting body; and
an assembled LED lamp strip structure received in the at least one hollow light-permitting body, wherein the assembled LED lamp strip structure comprises a substrate unit, a light-emitting unit and a packaging unit;
wherein the substrate unit has a plurality of substrate bodies sequentially and electrically connected to form a strip shape, and the substrate unit is electrically connected between the at least two conductive lateral covers;
wherein the light-emitting unit has a plurality of linear light-emitting arrays respectively disposed on and electrically connected to the substrate bodies, each linear light-emitting array has a plurality of light-emitting elements, and light beams generated by each light-emitting element are unobstructively projected outward through the at least one hollow light-permitting body;
wherein the packaging unit has a plurality of packaging bodies respectively disposed on the substrate bodies and respectively covering the linear light-emitting arrays, and the length of each packaging body is substantially the same as the length of each substrate body.

9. The LED lamp as claimed in claim 8, wherein each conductive lateral cover has a cover body and two conductive pins passing through the cover body and electrically connected to the substrate unit.

10. The LED lamp as claimed in claim 8, wherein each substrate body has at least four conductive pads disposed on a top surface thereof, two of the conductive pads are disposed on a first end region of each substrate body, the other two conductive pads are disposed on a second end region of each substrate body, the substrate unit has a plurality of conductive elements, and each conductive element is electrically connected between two adjacent conductive pads of two adjacent substrate bodies.

11. The LED lamp as claimed in claim 8, wherein the light-emitting elements of each linear light-emitting array are electrically connected with each other in series and in parallel.

12. The LED lamp as claimed in claim 8, wherein the packaging bodies are sequentially aligned to form a strip shape.

13. The LED lamp as claimed in claim 12, wherein each packaging body is phosphor resin.

14. The LED lamp as claimed in claim 13, wherein the phosphor resin is formed by mixing phosphor powders with silicone.

15. The LED lamp as claimed in claim 12, wherein each packaging body on each substrate body has an arc-shaped top surface.
